(19) United States
(12) Patent Application Publication
(10) Pub. No.: US 2006/0107294 A1
(43) Pub. Date: May 18, 2006

(54) Integrated video processing circuit and method for providing a displayed visual user interface for the display, selection and setup of video input sources

(76) Inventors: Ze'ev Rivlin, Ra'anana (IL); Yair Alpern, Kiryat Tivon (IL); Gady Yearim, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/274,688

(22) Filed: Nov. 14, 2005

Related U.S. Application Data
(60) Provisional application No. 60/627,964, filed on Nov. 16, 2004.

(51) Int. Cl. H04N 7/18; H04N 5/445; G06F 3/00

(52) U.S. Cl. 725/80; 725/37; 725/81

(57) ABSTRACT

An integrated video processing circuit (VPC) and method for providing a displayed visual user interface for the display, selection and setup of video input sources on a shared display. A VPC processes video from two or more video input sources, where some subset of the two or more video input sources receive video from a respective device. The VPC creates on the display a visual user interface consisting of live or interval-updated video providing simultaneously (e.g., in a mosaic of windows) a visual indication of the status of some or all of the video input sources. The VPC allows for the easy selection and setup of the respective devices via the user interface on the display and an input device (e.g., a remote control device).

### CROSS REFERENCE TO RELATED APPLICATIONS

This application claims priority to U.S. Provisional Application No. 60/627,964, filed on Nov. 16, 2004, by inventors Ze'ev Rivlin, Yair Alpern and Gady Yearim, entitled “Integrated Video Processing Circuit and Application Providing a Displayed Visual User Interface for Setup, Selection, and Display of Video Input Sources.”

### BACKGROUND

The importance for the consumer electronic device industry to continuously strive to produce products that are easy to use cannot be overstated. No doubt this is one of the reasons for the introduction of the home entertainment center and the remote control. For example, today's homes may have one or more electronic devices, such as televisions, digital video disk (DVD) players, video cassette recorder (VCR) players, compact disk (CD) players, set-top boxes, stereo receivers, audio/video receivers (AVR), media centers, personal video recorders (PVRs), gaming devices, digital camcorders, digital cameras, and so forth, all connected together in such a way to provide a user with a means for entertainment via the home entertainment center and a single display device. Each of these devices in the entertainment center typically has its own remote control. As the number of devices in the entertainment center continues to grow, so does the complexity and frustration for the user to be able to interface with all of the devices in the entertainment center. When a number of devices are input to a single display, there is a need to be able to select which of these devices is to be displayed. Presently, the most advanced method involves the use of a remote control with buttons corresponding to each of the various inputs—e.g., “TV”, “DVD”, “VCR”. In order to switch from one to the other, the user must push the button corresponding to the desired input. Although this sounds simple, it presents several challenges. One issue is the need to look on the remote control and read small text associated with the possible inputs. This can be challenging at times and for specific users (e.g., those with poor eye-sight), and is most challenging in the dark—e.g., wanting to switch to TV while watching a movie in the dark. Additionally, there is no easy way to see what are presently available inputs, or if a particular input is active before switching to it. Many displays lack multi-window capability which can be leveraged to improve the video selection interface. Yet other limitations of using a remote control for input selection is that many remote controls have too many buttons and the layout of the buttons on the remote control do not always match the intuitive placement users have in their minds for specific functions on particular devices. These limitations increase the frustration associated with using a remote control for input selection, especially in a dark room.

Without a good, easy-to-use solution for the remote control, even the simplest of tasks may be difficult to execute via the entertainment center, especially as the number of connected devices in the entertainment center continues to grow. For example, there is no easy way to know which of the devices are currently active in the entertainment center, there is no easy way to switch from one device to another in the entertainment center, and so forth.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of an environment for an integrated video processing circuit and method for providing a displayed visual user interface (DVUI), selection and setup of video input sources, in which some embodiments of the present invention may operate;

FIG. 2 illustrates one embodiment of an environment for an integrated video processing circuit and method for providing a DVUI for the display, selection and setup of video input sources, in which some embodiments of the present invention may operate;

FIG. 3 illustrates an embodiment of a remote control device with a simple set of buttons that may be used in conjunction with the present invention;

FIG. 4 illustrates an example DVUI, according to an embodiment of the invention;

FIG. 5 illustrates an example DVUI, according to an embodiment of the invention;

FIG. 6 illustrates an example DVUI, according to an embodiment of the invention;

FIG. 7 illustrates an embodiment of an integrated video processing circuit;

FIG. 8 illustrates an embodiment of an integrated video processing circuit;

FIG. 9 is a flow diagram of one embodiment of a process for the operation of providing a DVUI for the display, selection and setup of video input sources, in which some embodiments of the present invention may operate.

### DESCRIPTION OF EMBODIMENTS

According to an embodiment of the invention, an integrated video processing circuit and method for providing a displayed visual user interface (DVUI) for the display, selection and setup of video input sources are described. The user interface described includes both a DVUI and an input device. Here, at least some of the problems described above may be alievated by providing a DVUI for an entertainment center providing a visual indication of the current status of one or more devices in the entertainment center, and an easy way of selecting between the devices and setting up the devices. In the following description, for purposes of explanation, numerous specific details are set forth. It will be apparent, however, to one skilled in the art that embodiments of the invention can be practiced without these specific details.

The following definitions are provided to facilitate in the understanding of the invention and are not meant to limit the invention.

Video processing circuit (VPC)—Electronic circuit which processes video.

Displayed Visual User Interface (DVUI)—A user interface that is displayed on a display device (e.g., TV) and is seen by the user.

Input Device—A user interface device that allows for input to the display—e.g., a remote control, joystick, touch screen (in which example the display itself is the Input Device).

External Device—A device, external to the display which can house the VPC.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

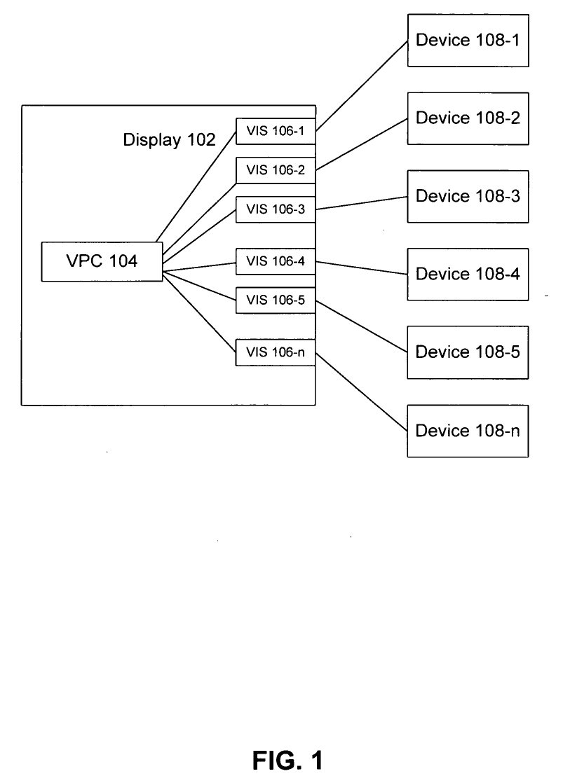

FIG. 1 illustrates one embodiment of an environment for an integrated video processing circuit and method for providing a DVUI for the display, selection and setup of video input sources, in which some embodiments of the present invention may operate. The specific components shown in FIG. 1 represent one example of a configuration that may be suitable for the invention and such example is not meant to limit the invention.

Referring to FIG. 1, the environment may include, but is not necessarily limited to, a display 102 and one or more devices 108 (shown as device 108-1 through 108-n). Display 102 is adapted to include a video processing circuit or device (VPC) 104 and one or more video input sources (VIS) 106 (shown as VIS 106-1 through 106-n). Display 102 may be implemented as a television or any type of monitor used for viewing video from devices 108. Each device 108 is connected to a video input source 106 to provide live video to VPC 104. The video may represent any standard or high definition video, or any graphics information. VPC 104 processes this live video data to produce a DVUI that is displayed on display panel of display 102. The DVUI may provide a visual indication of the current status of one or more devices in the entertainment center, and an easy way of selecting between the devices and setting up the devices.

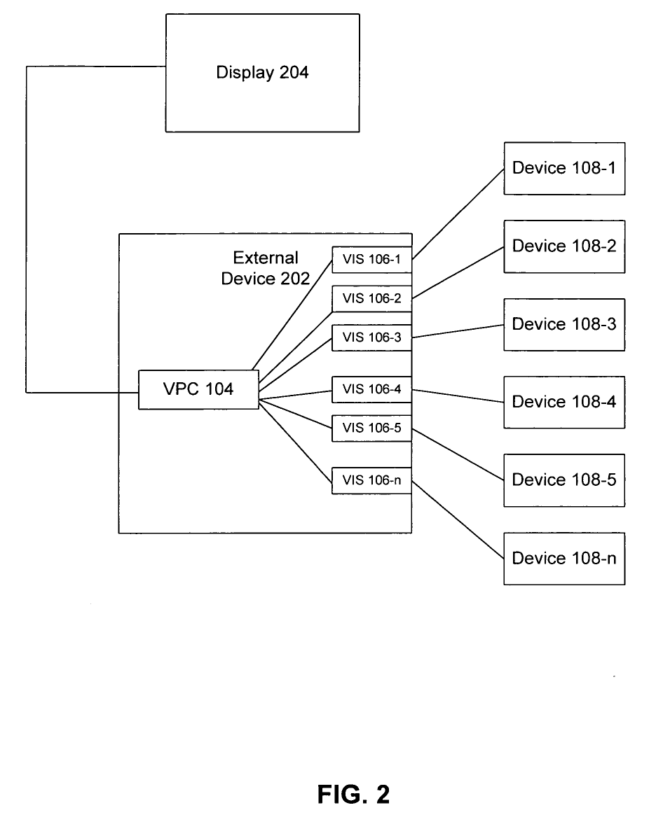

FIG. 2 illustrates another embodiment of an environment for an integrated video processing circuit and method for providing a DVUI for the display, selection and setup of video input sources. Here, VPC 104 and video input sources 106 are housed in an external device 202. External device 202 may be any device adapted for VPC 104 and video input sources 106. For example, external device 202 may be an audio/video (A/V) receiver, a set-top box, a high definition television (HDTV), a PVR, a media center, a computer, a DVD player, and so forth. As described above with reference to FIG. 1, VPC 104 processes live video data provided by devices 108 via video input sources 106 to produce a DVUI. In the embodiment of FIG. 2, the DVUI is displayed on display panel of display 204. Display 204 may be implemented as a television or any type of monitor used for viewing video from devices 108. In an embodiment of the invention, a single connection may be used to provide the live video data processed via VPC 104 to display 204.

In FIGS. 1 and 2, “n” indicates the number of video input sources (VIS) 106. The present invention has no theoretical limitation on the size of n, though practical implementation may have such—e.g., number of inputs to TV. For clarity, although FIG. 1 and FIG. 2 depict a device 108 connected to each VIS 106, as stated above, the embodiment of the environment contains one or more devices 108 with at most n devices.

The environment of FIGS. 1 and 2 may be implemented as a wired system, a wireless system, or a combination of both. Although the environment of FIGS. 1 and 2 may be illustrated using a particular connectivity by way of example, it may be appreciated that the principles and techniques discussed herein may be implemented using any type of connectivity and accompanying technology. The embodiments are not limited in this context. Other connectivity may be added or substituted according to the particular application for the environment in FIGS. 1 and 2 and/or as new types of systems are developed.

In an embodiment of the invention, when devices 108 are initially connected to video input sources 106, a default configuration may be triggered for the DVUI and displayed on display 102 or 204. For example, for each video input source 106, the configuration may include the following parameters: an automatic default display (e.g., appears automatically in a small video window or full screen of display 102 or 204); text labeling of the video window, where the text indicates the type of device 108; the position and/or size of the video window; the resolution and/or update interval for the video window; and the default action when video input source 106 becomes inactive (e.g., switch to another fixed VIS 106). All of the example parameters may be adjusted by the user. This example default configuration is provided for illustration purposes only and is not meant to limit the invention.

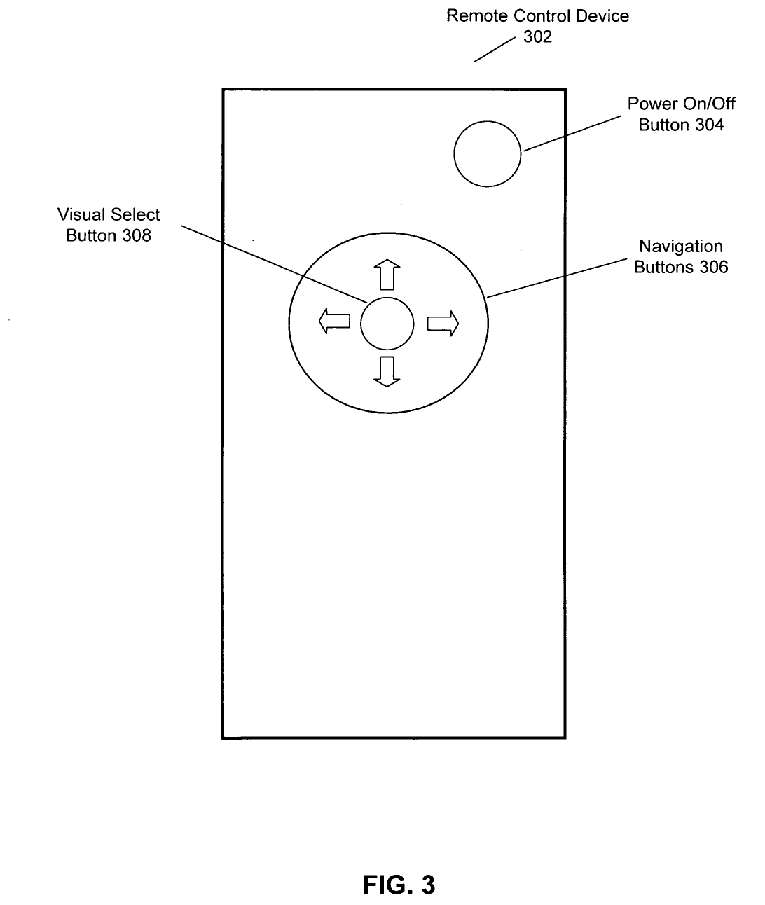

In an embodiment of the invention, the environment of FIGS. 1 and 2 may relate to a consumer electronics entertainment center environment. Here, devices 108 may be various consumer electronic devices found in the home environment, such as televisions, digital video disk (DVD) players, video cassette recorders (VCR), compact disk (CD) players, set-top boxes, stereo receivers, AVRs, media centers, personal video recorders (PVRs), gaming devices, digital camcorders, digital cameras, and so forth. The DVUI may provide a visual indication of the current status of one or more devices in the entertainment center, and an easy way of selecting between the devices and setting up the devices. Various embodiments of the displayed visual user interface will be described below with reference to FIGS. 3-6. This embodiment of a consumer electronics entertainment center environment is not meant to limit the invention and is provided for illustration purposes only. For example, the environment of FIG. 1 may relate to an office setting or any other environment where audio/video devices are connected.

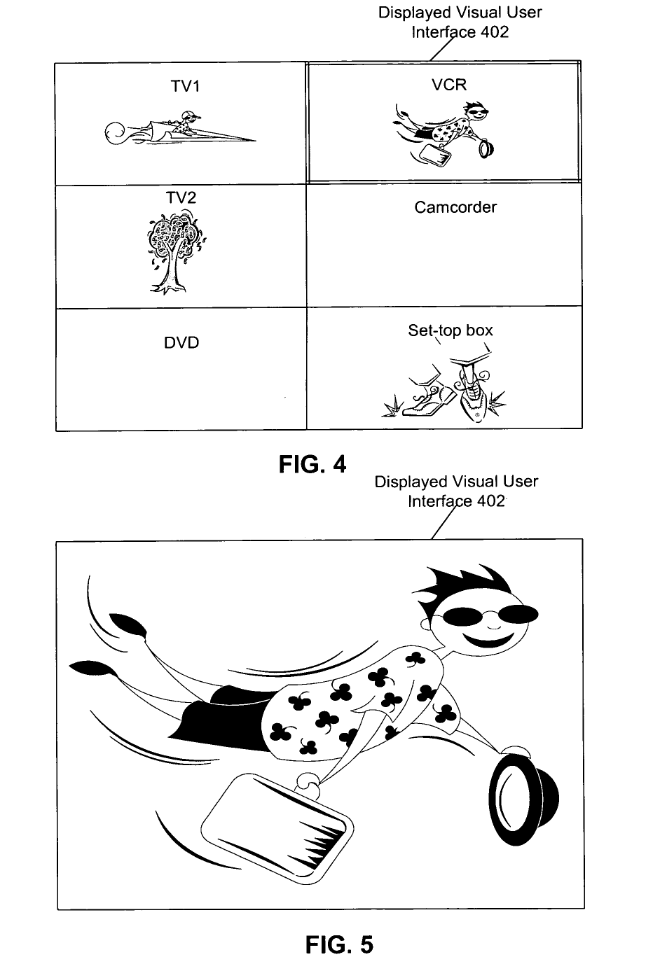

The DVUI displayed on either display 102 or 204 may be activated and/or manipulated in a variety of ways. For example, an input device such as a remote control or joystick or a touch screen on display 102 or 204, and so forth, may be used to activate/manipulate the DVUI. FIG. 3 illustrates an embodiment of a remote control device 302 with a simple set of buttons that may be used in conjunction with the present invention. Referring to FIG. 3, remote control device 302 may include, but is not necessarily limited to, a power on/off button 304, navigation buttons 306 (navigate up, down, left and right), and a visual select button 308. It is important to note that input selection may be achieved via a very intuitive single button and arrows. In an embodiment not meant to limit the invention, remote control device 302 utilizes a simple set of buttons in order to send commands to either display 102 or external device 202 to activate and/or manipulate the DVUI. For example, in an embodiment of the invention, remote control device 302 may be a typical handheld remote control that sends commands via infrared (IR) in order to select and activate soft control commands on the displayed visual user interface. In another embodiment of the invention, a similar set of buttons as shown on remote control device 302 may be implemented on a touch screen on display 102 or on a display which is part of the remote control device 302 itself. The buttons shown in FIG. 3 will be described next in more detail with reference to the example displayed visual user interfaces illustrated in FIGS. 4-6.

FIG. 4 illustrates an example DVUI 402 illustrating a mosaic of six (6) video windows, according to an embodiment of the invention. If the embodiment is such that VPC 104 and video input sources 106 are housed in an external device 202, the external device with VPC 104 may provide a mosaic (multi-window) capability to a display 204 that otherwise does not possess this capability. The mosaic of video windows may be activated by the user via Visual Select button 308 (toggle on/off) on remote control device 302. Referring to FIG. 4, in an example not meant to limit the invention, the mosaic of video windows illustrates that devices 108 consist of two television tuners (TV1 and TV2), a DVD, a VCR, a camcorder and a set-top box. In an embodiment of the invention, text indicating which device type is assigned to the specific video window may be displayed on the window itself. These specific types of devices are each connected to a video input source 106. Live video coming from these devices is processed via VPC 104 and is displayed on their respective video windows. In an embodiment of the invention, this live video may represent exactly what is currently being generated by the video input source of the devices or may represent the video input sources updated at short intervals. For example, TV1, TV2, VCR and set-top box are all currently providing live video to VPC 104. The DVD and camcorder are currently not providing any live video to VPC 104. As the number of devices 108 that are connected to VPC 104 via video input sources 106 increases or decreases, so may the number of video windows displayed in the mosaic of video windows.

In general, the mosaic of video windows can consist of all of the video input sources 106 (for example, for initial setup), or some subset of the video input sources 106. The subset can be determined as: The video input sources 106 that have a respective connected device 108; the video input sources 106 that have a respective connected device 108 that is turned on; the video input sources 106 that have a connected device 108 that is active (presently sending live video); the video input sources 106 that are selected by the user in customization of the mosaic; or any other subset of the video input sources 106. For the example in FIG. 4, these six (6) devices 108 may have been selected by the user as those to be displayed in the mosaic. There may be additional devices 108 that are connected and even active, but have not been selected by the user for viewing in the mosaic.

In an embodiment of the invention, for setup and/or configuration, information may be provided to the user via visual cues through the DVUI. These visual cues may provide a step-by-step guidance via a setup wizard for the user to follow and are superior to traditional simple text in aiding the user to setup and/or configure devices connected to his or her entertainment center. For example, the setup procedure may include actual pictures/graphics of the various example devices 108 and show their physical connectivity—e.g., show how the DVD connects to the AVR (acting as the external device). The setup procedure may include assignment of video input sources (VIS) 106, and respective devices 108 to specific configuration, including position of mosaic window and position, font, and size of associated text identifying the window. Finally, the wizard may prompt the user to actually play media from a device and check if it's connected properly—e.g., playing a DVD movie and seeing if it's displayed properly. The wizard may terminate once all devices 108 have been connected, configured, and successfully displayed on a mosaic.

In an embodiment of the invention for the more novice user, switching from one video source to another may be automatic. This functionality can be invoked by activating a “novice mode”. In the “novice mode”, for an example in which devices 108 include a set-top box for TV reception, a VCR, a DVD, and a camcorder, by default, the VPC 104 selects TV input and TV broadcast is sent to the display. When the user puts a movie in the DVD, and hits “play”, the VPC 104 automatically switches to and displays the DVD input showing the movie. Once the DVD is stopped, the VPC 104 automatically switches back to TV. If the user next connects the camcorder with home movie and hits “play”, VPC 104 switches automatically to camcorder for display. The idea is that for “novice mode”, the user need only know how to play different media types; VPC 104 takes care of selecting the appropriate input. In another embodiment of the invention, the user may utilize remote control device 302 and navigation buttons 306 to traverse through the mosaic of video windows of FIG. 4 to select the desired video input source. For example, the extra box, white border or highlight around the VCR video window in FIG. 4 illustrates that the VCR video window is currently highlighted. If, for example, the user would like to expand or select the highlighted VCR video window, the user may do so by activating the visual select button 308 of remote control device 302.

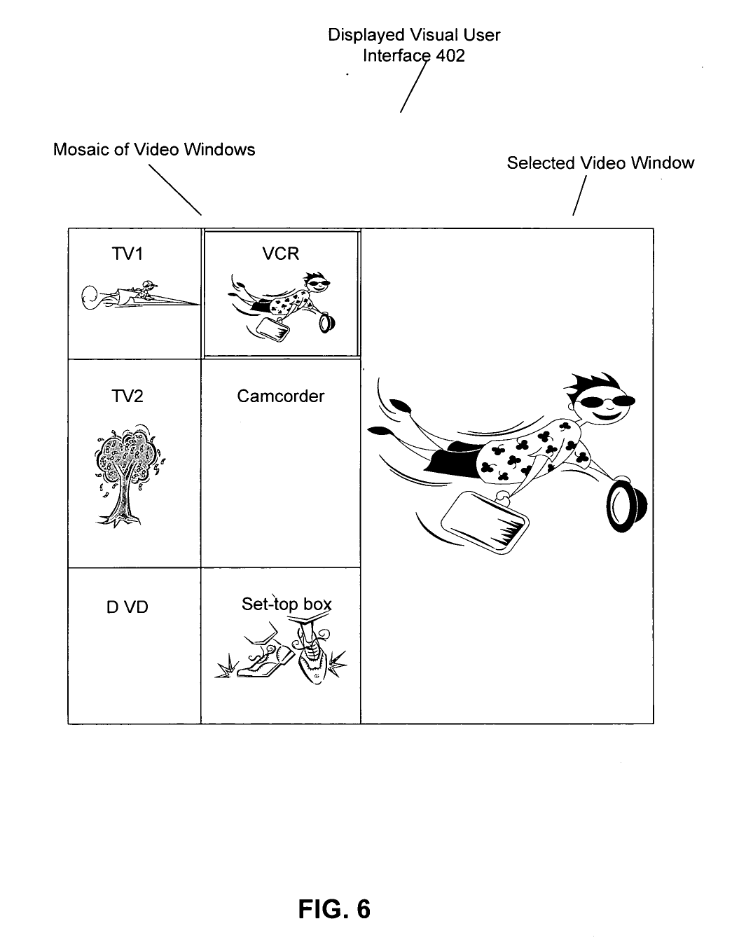

Once the user selects one of the video windows via the visual select button 308, the mosaic of video windows may be replaced by the selected video window, as illustrated in FIG. 5 and according to an embodiment of the invention. In another embodiment of the invention, once the user selects one of the video windows via the Visual Select button 308, the displayed visual user interface may be split and display both the mosaic of video windows (e.g., on the left side of the screen) and the selected video window (e.g., on the right side of the screen), as illustrated in FIG. 6. The example displayed visual user interfaces of FIGS. 4-6 are provided for illustration purposes only and are not meant to limit the invention.

The mosaic of video windows provides for an easy and intuitive way for a novice user to know exactly which devices are currently connected to his or her entertainment center, to know the current status of each of the connected devices (e.g., whether each device is currently displaying live video and exactly what that live video is) and to select between the devices for viewing of live video. For example, if the user wants to watch a DVD movie but wants to watch television until the DVD movie is successfully playing, the user may utilize the mosaic of video windows to provide a visual indication of when to highlight the DVD video window and press the visual select button 308 on the remote control. This helps to decrease the complexity and frustration for the user to be able to interface with all of the devices in the entertainment center.

Another feature of the present invention is that since the mosaic of video windows is displayed on display 102 or 204 and remote control device 302 consists of a single button and navigation “arrows” for input selection, the tasks of knowing exactly which devices are currently connected to an entertainment center, of knowing the current status of each of the connected devices (e.g., whether each device is currently displaying live video and exactly what that live video is) and of selecting between the devices for viewing of live video is easy, even in the dark. Furthermore, with proper lighting, viewing live video on a display is easier than locating text relevant to a particular device 108 on a remote control. This is particularly useful to users with poor vision, for which the text on the display windows, in addition to being illuminated on the display, can be made large. The size, text, location, and so forth, of the mosaic windows may be altered and the examples provided are not meant to limit the invention.

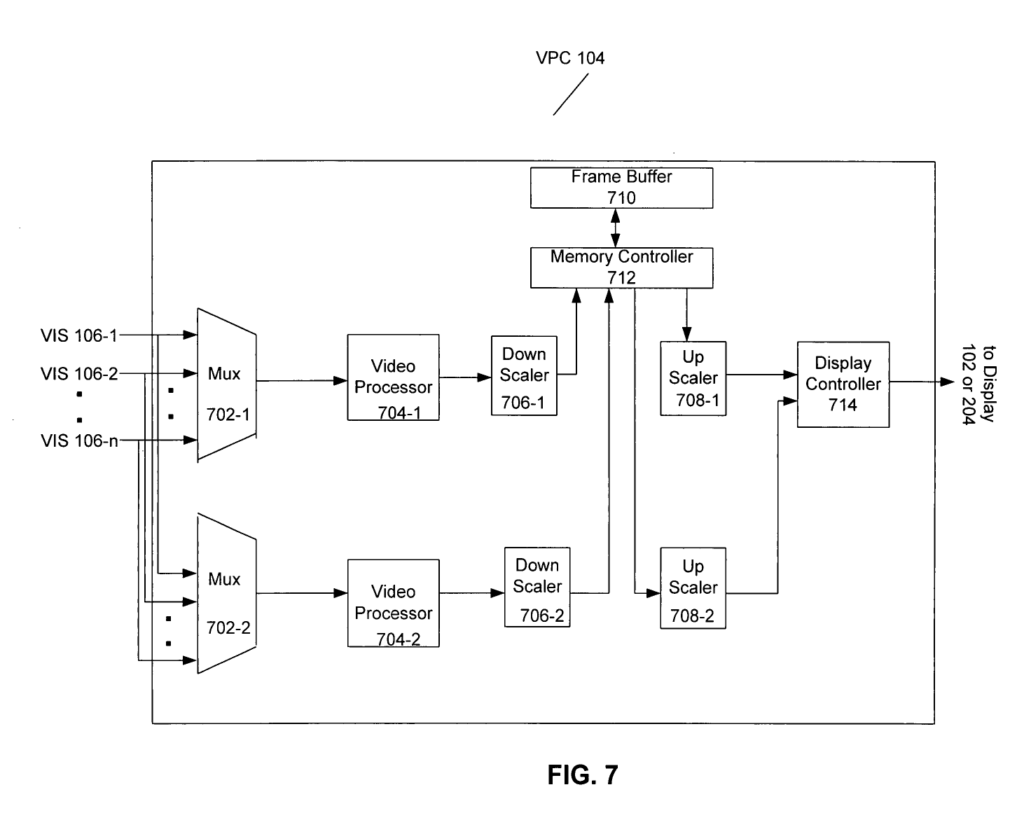

In an embodiment of the invention, the live video of the mosaic of video windows may represent exactly what is currently being generated by the video input source 106 of the devices 108 and received by VPC 104 or may represent the video input sources updated at short intervals. FIG. 7 illustrates an embodiment of an implementation of VPC 104 where VPC 104 produces a displayed visual user interface that includes both the mosaic of video windows updated at short intervals and the selected video window updated as the video is received at VPC 104 (as shown in FIG. 6). Referring to FIG. 7, VPC 104 may include, but is not necessarily limited to, multiplexers MUX 702-1 and 702-2, video processors 704-1 and 704-2, down scalers 706-1 and 706-2, up scalers 708-1 and 708-2, a frame buffer 710, a memory controller 712 and a display controller 714. MUX 702-1 and 702-2 receive video from VIS 106-1 through 106-n. The video may be any standard or high definition video, or any graphics information. Display controller 714 provides output to either display 102 or 204. Each of these components is described next in more detail.

The live video of the selected video window is processed by MUX 702-1. The video of the mosaic of video windows is refreshed one by one by MUX 702-2. Video processors 704-1 and 704-2 provide a digitized and processed image of the video from MUX 702-1 and 702-2. Down scalers 706-1 and 706-2 perform the required down scaling when needed to match the input resolution to the display resolution. In an embodiment of the invention, the display resolution may be the entire screen for selected video window or a smaller window size for a mosaic video window. Memory controller 712 may be used to control read and write pointers to frame buffer 710. Up scalers 708-1 and 708-2 may do any necessary frame reading from the memory to the display size. Display controller 714 provides the circuitry and functions for display 102 or 204. In an embodiment of the invention, the upper video signal path is composed of blocks marked with a ‘1’, and handles live video. Memory controller 712 reads and writes frames to the memory from the same source. The lower video signal path may be composed of blocks marked with a ‘2’, and handles the mosaic windows. Display controller 714 positions the outputs from the upper and lower video signal paths and sends them to display 102 or 204.

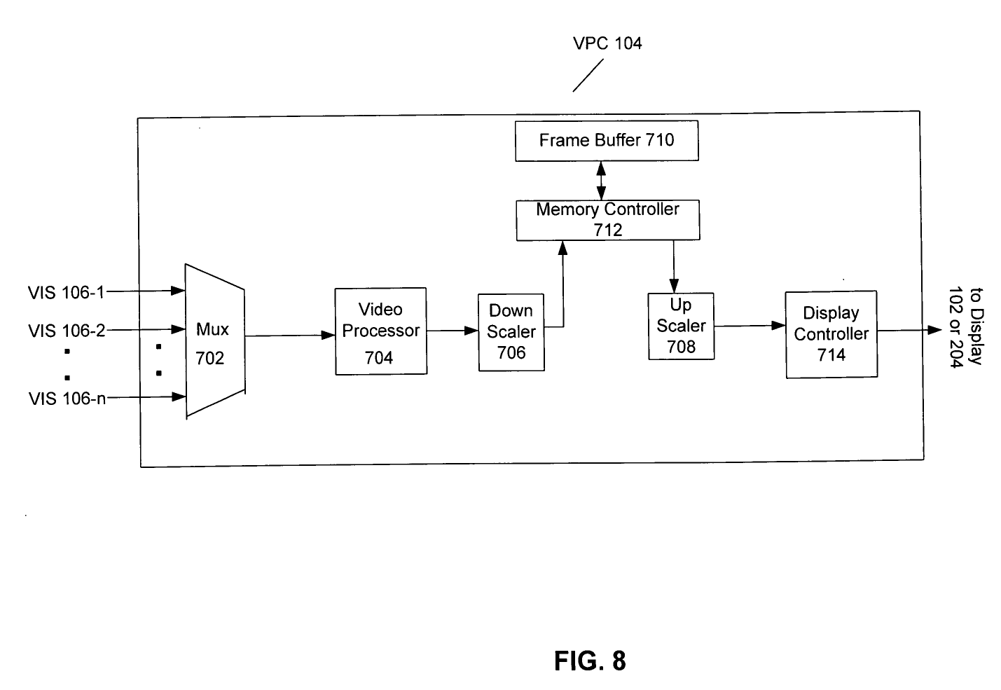

FIG. 8 illustrates an embodiment of an implementation of VPC 104 where VPC 104 produces a displayed visual user interface that includes the mosaic of video windows updated at short intervals. Here, the mosaic of video windows are refreshed one-by-one. MUX 702 determines which video window to process. Selection of the video window may be done in the order of the active inputs, although the invention is not limited to this. The remaining functionality of the components of FIG. 8 is similar to that described above with reference to FIG. 7. Both embodiments of an implementation of VPC 104 (FIG. 7 and FIG. 8) can produce the single video input source DVUI (For example, see FIG. 5).

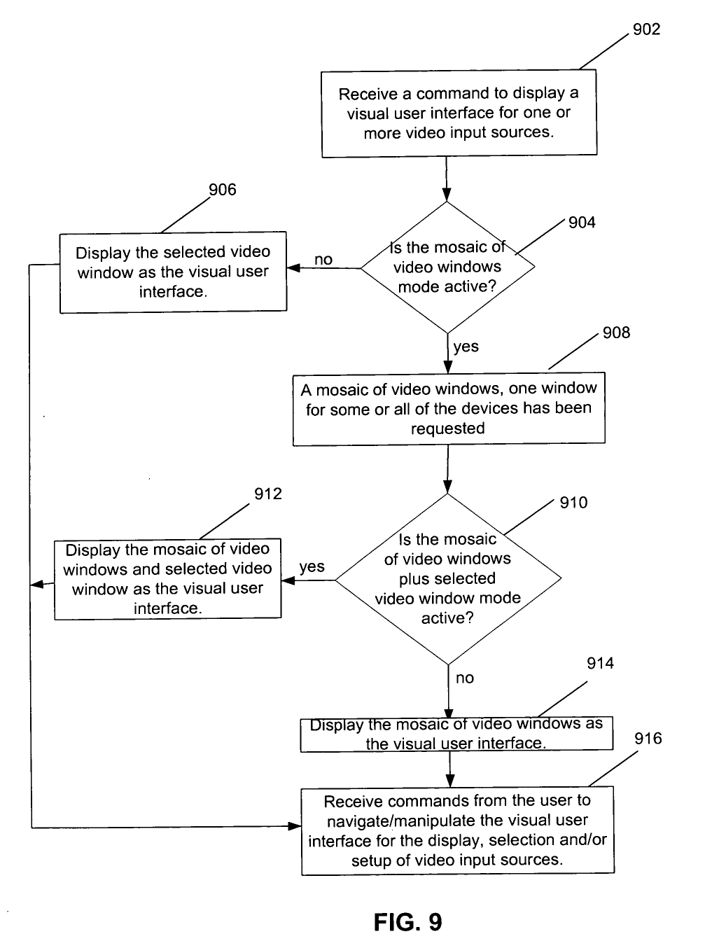

Embodiments of the operation of the present invention are described next with reference to FIG. 9. The flow diagram and other descriptions of processes herein are not intended to imply a fixed order of performing the process stages. Rather, the process stages may be performed in any order that is practicable.

FIG. 9 is a flow diagram of one embodiment of a process for the operation of providing a displayed visual user interface for the display, selection and setup of video input sources, in which some embodiments of the present invention may operate. Referring to FIG. 9, the process begins at processing block 902 where a command is received by VPC 104 to display a displayed visual user interface for one or more video input sources 106. In an embodiment of the invention, the command may be sent to VPC 104 via remote control device 302.

At decision block 904, it is determined whether the mosaic of video windows mode is active. If not, then at processing block 906, VPC 104 displays the selected video window as the displayed visual user interface (for example, see FIG. 5). If the mosaic of video windows mode is active—i.e., the mosaic mode has been requested (block 908), VPC 104 will create a mosaic of video windows with one window for some or all of the connected devices 108 of the type as determined by decision block 910.

At decision block 910, it is determined whether the mosaic of video windows plus selected video window mode is active. If yes, then at processing block 912, the mosaic of video windows and selected video window are displayed as the displayed visual user interface (for example, see FIG. 6). If only the mosaic of video windows mode is active, then at processing block 914, only the mosaic of video windows is displayed as the displayed visual user interface (for example, see FIG. 4).

At processing block 916, VPC 104 receives commands from the user to navigate and/or manipulate the displayed visual user interface for the display, selection and/or setup of video input sources 106.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A system comprising:
a video processing circuit (VPC); and
video input sources, wherein at least two of the video input sources to receive video from a respective device and wherein the VPC to process video from the respective devices; and
a user interface consisting of a displayed visual user interface (DVUI) and an input device, wherein the DVUI to provide a visual indication of the status of the at least two video input sources and the input device for user input.

2. The system of claim 1, wherein the VPC and the video input sources are housed in the display.

3. The system of claim 1, wherein the VPC and the video input sources are housed in a device external to the display.

4. The system of claim 3, wherein the external device is one of an audio/video receiver (AVR), set-top box, media center, digital video disk (DVD) player/recorder, video cassette recorder (VCR), compact disk (CD) player, stereo receiver, personal video recorder (PVR), gaming device, digital camcorder, and digital camera.

5. The system of claim 1, wherein the DVUI to represent a mosaic of video windows, wherein the mosaic of video windows is comprised of one video window for each of the at least two video input sources, and wherein the mosaic of video windows to be used to select and display a particular video input source via the input device.

6. The system of claim 5, wherein the VPC to deliver live video or refresh the mosaic of video windows in intervals as live video is received at the VPC.

7. The system of claim 1, wherein each respective device is one of an audio/video receiver (AVR), set-top box, media center, digital video disk (DVD) player/recorder, video cassette recorder (VCR), compact disk (CD) player, stereo receiver, personal video recorder (PVR), gaming device, digital camcorder, and digital camera.

8. The system of claim 1, wherein the DVUI to provide visual cues to configure or set-up each of the respective devices.

9. The system of claim 1, wherein a video input source is automatically selected and respective device's video displayed on the display based on manipulation of one of the respective devices by the user or based on a pre-configured default.

10. The system of claim 5, wherein the DVUI to provide visual cues, and be manipulated by a user via a remote control device or joystick limited to one or more navigation buttons and a visual select button.

11. A video processing circuit (VPC) to receive video from video input sources, wherein at least two video input sources to receive video from a respective device, wherein the VPC to process video from the at least two video input sources and to display the processed video as a DVUI on a display, and wherein the DVUI to provide a visual indication of the status of the at least two video input sources.

12. The VPC of claim 11, wherein the VPC and the at least two video input sources are housed in the display.

13. The VPC of claim 11, wherein the VPC and the at least two video input sources are housed in a device external to the display.

14. The VPC of claim 13, wherein the external device is one of an audio/video receiver (AVR), set-top box, media center, digital video disk (DVD) player/recorder, video cassette recorder (VCR), compact disk (CD) player, stereo receiver, personal video recorder (PVR), gaming device, digital camcorder, and digital camera.

15. The VPC of claim 11, wherein the DVUI to represent a mosaic of video windows, wherein the mosaic of video windows is comprised of one video window for each of the at least two video input sources, and wherein the mosaic of video windows to be used to select and display a particular video input source via the input device.

16. The VPC of claim 15, wherein the VPC to deliver live video or refresh the mosaic of video windows in intervals as live video is received at the VPC.

17. The VPC of claim 11, wherein each respective device is one of an audio/video receiver (AVR), set-top box, media center, digital video disk (DVD) player/recorder, video cassette recorder (VCR), compact disk (CD) player, stereo receiver, personal video recorder (PVR), gaming device, digital camcorder, and digital camera.

18. The VPC of claim 11, wherein DVUI to provide visual cues to configure or set-up each of the respective devices.

19. The VPC of claim 11, wherein a video input source is automatically selected and respective device's video displayed on the display based on manipulation of one of the respective devices by the user or based on a pre-configured default.

20. The VPC of claim 11, wherein the DVUI to provide visual cues, and be manipulated by a user via a remote control device or joystick limited to one or more navigation buttons and a visual select button.

21. A method comprising:
receiving video from video input sources, wherein at least two of the video input sources receive video from a respective device;
processing the video received at the at least two video input sources to create a user interface consisting of a displayed visual user interface (DVUI) and an input device, wherein the DVUI to provide a visual indication of the status of the at least two video input sources and the input device for user input.

22. The method of claim 21, wherein the VPC and the video input sources are housed in the display.

23. The method of claim 21, wherein the VPC and the video input sources are housed in an external device (device external to the display).

24. The method of claim 23, wherein the external device is one of an audio/video receiver (AVR), set-top box, media center, digital video disk (DVD) player/recorder, video cassette recorder (VCR), compact disk (CD) player, stereo receiver, personal video recorder (PVR), gaming device, digital camcorder, and digital camera.

25. The method of claim 21, wherein the DVUI to represent a mosaic of video windows, wherein the mosaic of video windows is comprised of one video window for each of the at least two video input sources, and wherein the mosaic of video windows to be used to select and display a particular video input source via the input device.

26. The method of claim 25, further comprising:
delivering live video or refreshing the mosaic of video windows one video window at a time in intervals as live video is received.

27. The method of claim 21, wherein each respective device is one of an audio/video receiver (AVR), set-top box, media center, digital video disk (DVD) player/recorder, video cassette recorder (VCR), compact disk (CD) player, stereo receiver, personal video recorder (PVR), gaming device, digital camcorder, and digital camera.

28. The method of claim 21, wherein the DVUI to provide visual cues to configure or set-up each of the respective devices.

29. The method of claim 21, further comprising:
automatically displaying a respective device's video on a display based on manipulation of one of the respective devices by the user or based on a pre-configured default.

30. The method of claim 21, wherein the DVUI to provide visual cues, and be manipulated by a user via a remote control device or joystick limited to one or more navigation buttons and a visual select button.
